(19) United States
(12) Patent Application Publication
(10) Pub. No.: US 2025/0273773 A1
(43) Pub. Date: Aug. 28, 2025

(54) SEPARATOR ATTACHMENT IN METAL-AIR BATTERIES

(71) Applicant: Form Energy, Inc., Somerville, MA (US)

(72) Inventors: Emily C. PITT, Boston, MA (US); Derek PAXSON, Boston, MA (US)

(21) Appl. No.: 19/061,774

(22) Filed: Feb. 24, 2025

Related U.S. Application Data
(60) Provisional application No. 63/556,662, filed on Feb. 22, 2024.

(51) Int. Cl. H01M 12/06; H01M 4/86; H01M 12/02; H01M 12/08

(52) U.S. Cl. CPC H01M 12/065; H01M 4/8626; H01M 12/02; H01M 12/08

(57) ABSTRACT

An electrochemical cell may include an anode, a gas diffusion electrode (GDE), an oxygen evolution electrode (OEE); a vessel, a separator, and at least one standoff. The vessel may define a volume in which the OEE, the GDE, and the anode are each at least partially disposed with the OEE between the anode and the GDE. The separator may be ionically conductive and electrically insulative and disposed between the anode and the OEE. The at least one standoff may space the OEE from the anode, the at least one standoff penetrating the separator at discontinuities and forming at least a portion of respective liquid tight seals with the separator at the discontinuities.

### CROSS-REFERENCE TO RELATED APPLICATIONS

This application claims the benefit of priority to U.S. Provisional Application No. 63/556,662, filed Feb. 22, 2024, the entire contents of which are hereby incorporated herein by reference.

### BACKGROUND

Energy storage technologies are playing an increasingly important role in electric power grids. These energy storage assets provide smoothing to better match generation and demand on a grid. The services performed by energy storage devices are beneficial to electric power grids across multiple time scales, from milliseconds to years. Today, energy storage technologies exist that can support timescales from milliseconds to hours, but there is a need for increased availability, reliability, and/or resiliency with reduced costs in energy storage systems.

### SUMMARY

According to an aspect, an electrochemical cell may include an anode; a gas diffusion electrode (GDE); an oxygen evolution electrode (OEE); a vessel defining a volume in which the OEE, the GDE, and the anode are each at least partially disposed with the OEE between the anode and the GDE; a separator, the separator ionically conductive and electrically insulative, the separator between the anode and the OEE; and at least one first standoff spacing the OEE from the anode, the at least one first standoff penetrating the separator at discontinuities and forming at least a portion of respective liquid tight seals with the separator at the discontinuities.

In some implementations, the at least one first standoff may include an elongate body, and the at least one first standoff penetrates the separator at the discontinuities along a longitudinal dimension of the elongate body. The at least one first standoff may be a plurality of first standoffs spaced apart from one another between the OEE and the anode such that the plurality of first standoffs define at least one channel, between the OEE and the anode, along which bubbles from the anode are flowable. In some instances, the at least one first standoff may be polymeric. Further, a melt temperature of the at least one first standoff may be less than a melt temperature of the separator. In some instances, the at least one first standoff may include a plurality of bosses and a plurality of washers, each one of the plurality of bosses is supported on the elongate body and penetrates the separator at the discontinuities, and each one of the plurality of bosses is heat staked on a respective one of the plurality of washers with the separator sandwiched between the respective one of the plurality of washers and the elongate body.

In certain implementations, the electrochemical cell may further include at least one second standoff, wherein the at least one second standoff spaces the OEE away from the GDE. As an example, the OEE may have a first surface and a second surface opposite one another, the OEE defines a plurality of holes from the first surface to the second surface, the separator is sandwiched between the first surface of the OEE and the at least one first standoff, the at least one second standoff is disposed on the second surface of the OEE, and the at least one first standoff, the separator, and the at least one second standoff are mechanically secured to one another through the plurality of holes of the OEE. The at least one first standoff, the at least one second standoff, and the separator may collectively form liquid tight seals over the plurality of holes defined by the OEE. In some instances, the at least one first standoff, the separator, the at least one second standoff may be mechanically coupled to one another at a plurality of ultrasonic welds, and each one of the plurality of ultrasonic welds extends through a respective one of the plurality of holes of the OEE. As an example, the at least one first standoff, the at least one second standoff, or both may include a plurality of protrusions, and each one of the plurality of protrusions forms a portion of the respective one of the plurality of ultrasonic welds extending through the given one of the plurality of holes of the OEE. In some instances, the electrochemical cell may further include a plurality of polymeric staples, wherein each one of the plurality of polymeric staples extends through a respective one of the plurality of holes of the OEE and mechanically couples the at least one first standoff, the separator, and the at least one second standoff to one another. Each one of the polymeric staples may include a respective pair of points extending in a direction toward the anode.

In some implementations, the separator may be impermeable to bubbles generatable by the anode.

In certain implementations, the separator may be a polymeric film. For example, the polymeric film may be polypropylene.

In some implementations, the anode may be a metal electrode (e.g., an iron electrode).

In certain implementations, the electrochemical cell may further include an electrolyte, wherein the anode, the OEE, and the GDE are each at least partially submerged in the electrolyte in the volume of the vessel.

According to another aspect, a separator for an electrochemical cell may include: a plurality of filaments; and a substrate, the substrate ionically conductive and electrically insulative, the plurality of filaments extending in a direction away from the substrate, and each of the plurality of filaments attached to the substrate at discrete locations along a longitudinal dimension of the respective filament.

In certain implementations, attachment of each of the plurality of filaments to the substrate at the discrete locations may include welds at the discrete locations.

In some implementations, each filament may have a circular cross-section away from the respective discrete locations at which the given filament is attached to the substrate.

In certain implementations, the base material of the separator may be a nonwoven material.

In some implementations, the substrate and the plurality of filaments may each be polymeric. For example, the substrate and the plurality of filaments may each be polyolefin-based polymers.

In certain implementations, the plurality of filaments may be discretely spaced apart from one another. For example, the plurality of filaments may be parallel to one another such that the plurality of filaments define channels therebetween. Further, or instead, the plurality of filaments may be in a linear orientations. Additionally, or alternatively, the plurality of filaments may be in curvilinear orientations.

In some implementations, at least a subset of the plurality of filaments may be attached to the substrate partially overlap one another.

In certain implementations, each of the plurality of filaments may have a circular cross-section away from the discrete locations of attachment of the plurality of filaments to the substrate. For example, each of the plurality of filaments may have a diameter of 1 mm to 2 mm away from the discrete locations of attachment of the plurality of filaments to the substrate.

In some implementations, the plurality of filaments may be electrically insulative and ionically impermeable, and the plurality of filaments cover 5 percent to 30 percent of the overall area of the substrate.

### DESCRIPTION OF THE DRAWINGS

FIG. 1 is a system block diagram of a power generation system according to various embodiments.

FIG. 2 is a system block diagram of a power generation system according to various embodiments.

FIG. 3 is a schematic representation of components of an electrochemical cell.

FIG. 4A is a perspective view of an outer portion of an electrochemical cell.

FIG. 4B is an exploded diagram of internal portions of the electrochemical cell of FIG. 4A.

FIG. 4C is a schematic representation of the arrangement of electrodes of the electrochemical cell shown in FIG. 4A.

FIG. 4D is a schematic representation of an arrangement of electrodes of an electrochemical cell, the arrangement of electrodes including a respective anode assembly between a respective oxygen evolution electrode (OEE) on either side of a gas diffusion electrode.

FIG. 5 is a schematic representation of a cathode including a separator.

FIG. 6A is a schematic representation of an electrochemical cell including a separator supported on an oxygen evolution electrode and standoffs supporting the separator and the oxygen evolution electrode away from an anode and away from a gas diffusion electrode.

FIG. 6B is a schematic representation of a front view of the separator and standoffs of FIG. 6A, with at least one of the standoffs penetrating the separator at discontinuities.

FIG. 6C is a close-up, side view of a cross-section of the separator and one of standoffs, with the cross-section taken along 6C-6C in FIG. 6B.

FIG. 6D is a front view of the components FIG. 6C prior to connecting the standoff to the separator.

FIG. 6E is a schematic representation of an arrangement of the components of FIG. 6D prior to heat staking the standoff to the separator to form the connection shown in FIG. 6C.

FIG. 7 is a schematic side view of the standoffs, the separator, and the oxygen evolution electrode of FIG. 6A mechanically coupled to one another via a weld extending through a hole defined by the oxygen evolution electrode.

FIG. 8 is a schematic side of standoffs, a separator, and an oxygen evolution electrode mechanically coupled to one another via a polymeric staple extending through a hole defined by the oxygen evolution electrode.

FIG. 9 is a front view of a separator including a plurality of filaments secured to a substrate in a linear orientation.

FIG. 10 is a front view of a separator including a plurality of filaments secured to a substrate in a curvilinear orientation.

FIG. 11 is front view of a separator including a plurality of filaments secured to a substrate in an overlapping orientation.

Like reference symbols in the various drawings indicate like elements.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments is not intended to be limiting and, instead, is intended to enable a person skilled in the art to make and use these embodiments or combinations thereof.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and, with existing equipment or activities which may be modified, in-part, based on the teachings of this specification. Further, the various embodiments and examples set forth in this specification may be used with each other, in whole or in part, and in different and various combinations. Thus, the configurations provided in the various embodiments of this specification may be used with each other. For example, the components of an embodiment having A, A′ and B and the components of an embodiment having A″, C and D can be used with each other in various combinations, e.g., A, C, D, and A. A″ C and D, etc., in accordance with the disclosure provided herein. Thus, the scope of the present disclosure should not be limited to a particular embodiment, configuration or arrangement that is set forth in a particular embodiment, example, or in an embodiment in a particular figure.

Embodiments of the present disclosure may include systems, methods, and devices for electrochemical energy storage systems, such as metal-air battery systems. Systems and methods of the various embodiments may provide for construction and configuration of electrodes and/or cell components of metal-air battery systems.

Various embodiments may provide devices and/or methods for use in long-duration, and ultra-long-duration, low-cost, energy storage, including in multi-day energy storage. Herein, “long duration” and “ultra-long duration” and similar such terms, unless expressly stated otherwise, should be given their broadest possible meaning and include periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. and would include long duration energy storage (LODES) systems. Further, the terms “long duration” and “ultra-long duration”, “energy storage cells” including “electrochemical cells”, and similar such terms, unless expressly stated otherwise, should be given their broadest possible interpretation; and include electrochemical cells that may be configured to store energy over time spans of days, weeks, or seasons, such as electrochemical cells sometimes referred to as multi-day energy storage (MDS) cells. As a matter of definition, the term “duration” means the ratio of energy to power of an energy storage system. For example, a system with a rated energy of 24 MWh and a rated power of 8 MW has a duration of 3 hours; a system with a rated energy of 24 MWh and a rated power of 1 MW has a duration of 24 hours. Physically, this may be interpreted as the run-time at maximum power for the energy storage system.

In general, in an embodiment, the long duration energy storage cell can be a long duration electrochemical cell. In general, this long duration electrochemical cell can store electricity generated from an electrical generation system, when: (i) the power source or fuel for that generation is available, abundant, inexpensive, and combinations and variations of these; (ii) when the power requirements or electrical needs of the electrical grid, customer or other user, are less than the amount of electricity generated by the electrical generation system, the price paid for providing such power to the grid, customer or other user, is below an economically efficient point for the generation of such power (e.g., cost of generation exceeds market price for the electricity), and combinations and variations of these; and (iii) combinations and variations of (i) and (ii) as well as other reasons. This electricity stored in the long duration electrochemical cell can then be distributed to the grid, customer or other user, at times when it is economical or otherwise needed. For example, the electrochemical cells may be configured to store energy generated by solar cells during the summer months, when sunshine is plentiful and solar power generation exceeds power grid requirements, and discharge the stored energy during the winter months, when sunshine may be insufficient to satisfy power grid requirements.

Various embodiments may provide devices and/or methods for use in bulk energy storage systems, such as long duration energy storage (LODES) systems (e.g., multi-day energy storage (MDS) systems), short duration energy storage (SDES) systems, etc. As an example, various embodiments may provide configurations and controls for batteries of bulk energy storage systems, such as batteries for LODES systems.

While various examples are discussed with reference to Li-ion and/or Fe-air, the discussion of Li-ion and/or Fe-air is used merely as an example and various embodiments encompass other combinations and permutations of storage technologies that may be substituted for the example solar+Li-ion+Fe-air discussions herein. For example, various metal-air storage technologies may be used as batteries in the various embodiments, such as Zinc-air, lithium-air, sodium-air, etc.

As used herein, the term “module” may refer to a string of unit electrochemical cells (e.g., a string of batteries). Multiple modules (or multiple units or electrochemical cells) may be connected together to form battery strings.

Unless otherwise expressed or made clear from the context, the recitation of any element in the singular shall be understood to be intended to encompass embodiments including one or more of such elements and the separate recitation of “one or more” is generally omitted for the sake of clarity and readability. Thus, for example, recitation of a LODES system 104 shall be understood to be inclusive of one or more LODES systems, etc.

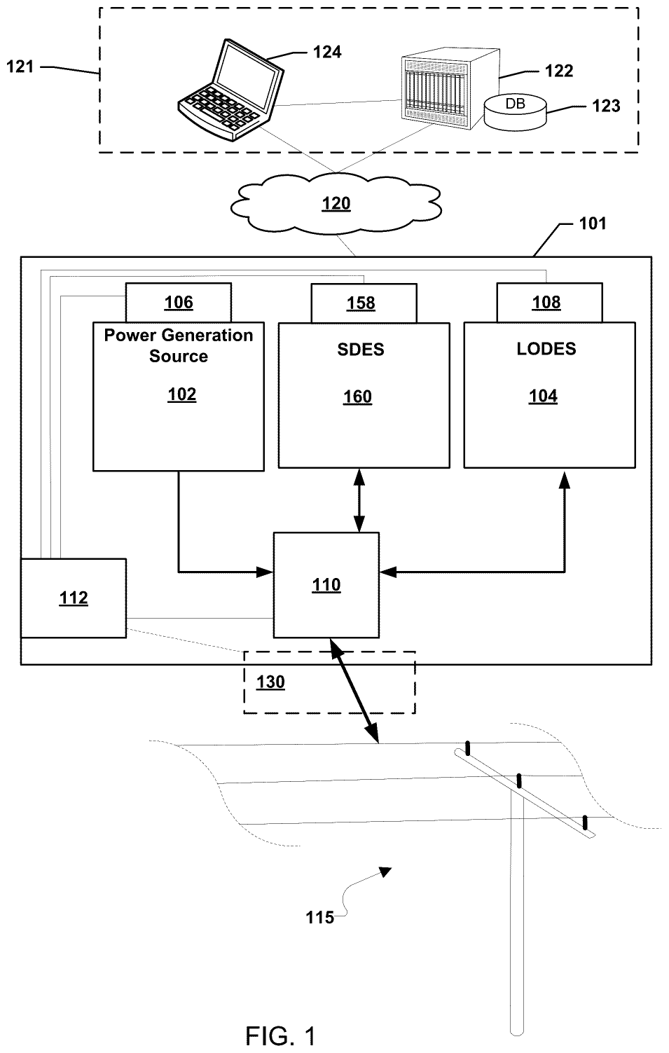

FIG. 1 is a system block diagram of a power generation system 101 according to various embodiments. The power generation system 101 may be a power plant including a power generation source 102, a LODES systems 104 (e.g., a multi-day energy storage (MDS) system), and an SDES systems 160. As examples, the power generation source 102 may include renewable power generation sources, non-renewable power generation sources, combinations of renewable and non-renewable power generation sources, etc. Examples of the power generation sources 102 include wind generators, solar generators, geothermal generators, nuclear generators, etc. The LODES system 104 may include an electrochemical cell (e.g., one or more batteries). The batteries of the LODES systems 104 may be any type of battery, such as rechargeable secondary batteries, refuellable primary batteries, combinations of primary and secondary batteries, etc. Battery chemistries may be any suitable chemistry, such as Al, AlCl₃, Fe, FeOₓ(OH)_{y}, NaₓS_{y}, SiOₓ(OH)_{y}, AlOₓ(OH)_{y}, metal-air, and/or any suitable type of battery chemistry. The SDES systems 160 may include one or more electrochemical cells (e.g., one or more batteries). The batteries of the SDES systems 160 may be any type of battery, such as rechargeable secondary batteries, refuellable primary batteries, combinations of primary and secondary batteries, etc. Battery chemistries may be any suitable chemistry, such as Li-ion, Na-ion, NiMH, Mg-ion, and/or any suitable type of battery chemistry.

In various embodiments, the operation of the power generation source 102 may be controlled by a first control system 106. The first control system 106 may include motors, pumps, fans, switches, relays, or any other type of devices that may control the generation of electricity by the power generation source 102. In various embodiments, the operation of the LODES system 104 may be controlled by a second control system 108. The second control system 108 may include motors, pumps, fans, switches, relays, or any other type of devices that may control the discharge and/or storage of electricity by the LODES system. In various embodiments, the operation of the SDES system 160 may be controlled by a third control system 158. The third control system 158 may include motors, pumps, fans, switches, relays, or any other type of devices that may control the discharge and/or storage of electricity by the SDES system 160. The first control system 106, the second control system 108, and the third control system 158 may each be connected to a plant controller 112. The plant controller 112 may monitor the overall operation of the power generation system 101 and generate and send control signals to the first control system 106, the second control system 108, and the third control system 158 to control the operations of the power generation source 102, the LODES system 104, and/or the SDES system 160.

In the power generation system 101, the power generation source 102, the LODES system 104, and the SDES system 160 may each be connected to a power control device 110. The power control device 110 may be connected to a power grid 115 or other transmission infrastructure. The power control device 110 may include switches, inverters (e.g., AC to DC inverters, DC to AC inverters, etc.), relays, power electronics, and any other type of devices that may control the flow of electricity from to/from the power generation source 102, the LODES system 104, the SDES system 160, and/or the power grid 115. Additionally, or alternatively, the power generation system 101 may include transmission facilities 130 connecting the power generation, transmission, and the power generation system 101 to the power grid 115. As an example, the transmission facilities 130 may connect between the power control device 110 and the power grid 115 such that electricity may flow between the power generation system 101 and the power grid 115. Transmission facilities 130 may include transmission lines, distribution lines, power cables, switches, relays, transformers, and any other type of devices that may support the flow of electricity between the power generation system 101 and the power grid 115. The power control device 110 and/or the transmission facilities 130 may be connected to the plant controller 112. The plant controller 112 may monitor and control the operations of the power control device 110 and/or the transmission facilities 130, such as via various control signals. As examples, the plant controller 112 may control the power control device 110 and/or the transmission facilities 130 to provide electricity from the power generation source 102 to the power grid 115, to provide electricity from the LODES system 104 to the power grid 115, to provide electricity from both the power generation source 102 and the LODES system 104 to the power grid 115, to provide electricity from the power generation source 102 to the LODES system 104, to provide electricity from the power grid 115 to the LODES system 104, to provide electricity from the SDES system 160 to the power grid 115, to provide electricity from both the power generation source 102 and the SDES system 160 to the power grid 115, to provide electricity from the power generation source 102 to the SDES system 160, to provide electricity from the power grid 115 to the SDES system 160, to provide electricity from the SDES system 160 and the LODES system 104 to the power grid 115, and/or to provide electricity from the power generation source 102, the SDES system 160, and the LODES system 104 to the power grid 115. In various embodiments, the power generation source 102 may selectively charge the LODES system 104 and/or SDES system 160 and the LODES system 104 and/or SDES system 160 may selectively discharge to the power grid 115. In this manner, energy (e.g., renewable energy, non-renewable energy, etc.) generated by the power generation source 102 may be output to the power grid 115 sometime after generation from the LODES system 104 and/or the SDES system 160.

In various embodiments, the plant controller 112 may be in communication with a network 120 (e.g., 3G network, 4G network, 5G network, core network, Internet, combinations of the same, etc.). Using the connections to the network 120, the plant controller 112 may exchange data with the network 120 as well as with devices connected to the network 120, such as a plant management system 121 or any other device connected to the network 120. The plant management system 121 may include one or more computing devices, such as a computing device 124 and a server 122. The computing device 124 and the server 122 may be connected to one another directly and/or via connections to the network 120. The various connections to the network 120 by the plant controller 112 and devices of the plant management system 121 may be wired and/or wireless connections.

In various embodiments, the computing device 124 of the plant management system 121 may provide a user interface that facilitates providing user-defined inputs to the plant management system 121 and/or to the power generation system 101, receiving indications associated with the plant management system 121 and/or with the power generation system 101, and/or otherwise controlling operation of the plant management system 121 and/or the power generation system 101.

While shown as two separate devices, 124 and 122, the functionality of the computing device 124 and server 122 described herein may be combined into a single computing device or may split among more than two devices. Additionally, or alternatively, while shown as part of the plant management system 121, the functionality of one or both the computing device 124 and the server 122 may be entirely, or partially, carried out by a remote computing device, such as a cloud-based computing system. Further, or instead, while shown as being in communication with a single instance of the power generation system 101, the plant management system 121 may be in communication with multiple instances of the power generation system 101.

While shown as being located together in FIG. 1, the power generation source 102, the LODES system 104, and the SDES system 160 may be physically separated from one another in various implementations. For example, the LODES system 104 may be downstream of a transmission constraint, such as downstream of a portion of the power grid 115, downstream from the power generation source 102 and SDES system 160, etc. In this manner, the overbuild of underutilized transmission infrastructure may be reduced, or even avoided, by situating the LODES system 104 downstream of a transmission constraint, charging the LODES system 104 at times of available capacity and discharging the LODES system 104 at times of transmission shortage. The LODES system 104 may also, or instead, arbitrate electricity according to prevailing market prices to reduce the final cost of electricity to consumers.

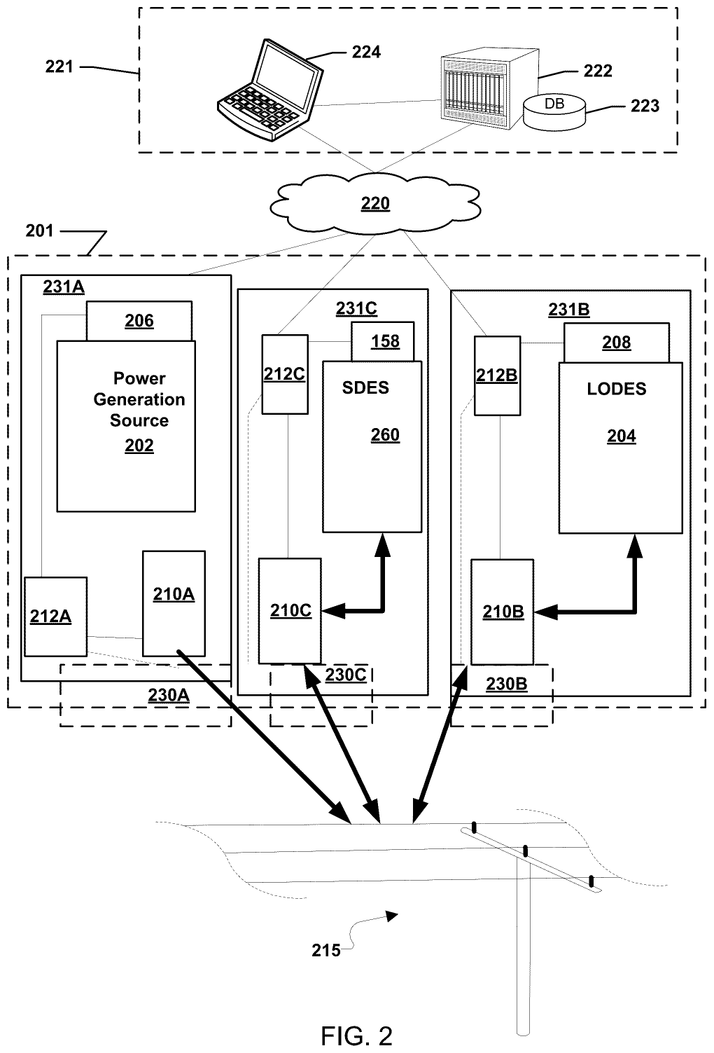

FIG. 2 is a system block diagram of a power generation system 201 in which various elements of the power generation system 201 may be physically separated from one another according to various embodiments. For the sake of clear and efficient description, elements in FIG. 2 with numbers having the same last two digits as in FIG. 1 shall be understood to be analogous to or interchangeable with one another, unless otherwise specified or made clear from the context, and, therefore, are not described separately from one another, except to note differences and/or to emphasize certain features. For example, the power generation system 101 (FIG. 1) shall be understood to be analogous to and/or interchangeable with the power generation system 201, unless a contrary intent is expressed or made clear from the context.

As an example, the power generation system 201 may include a power generation source 202 and one or more bulk energy storage systems, such as a LODES system 204 and/or an SDES system 260. The power generation source 202, the LODES system 204, and/or the SDES system 160 may be separated in the power plants 231A, 231B, 231C, respectively. While the power plants 231A, 231B, 231C may be separated from one another, the power generation system 201 and a plant management system 121 may operate as described above with reference to operation of the power generation system 101 and the plant management system 121 (FIG. 1). While the power plants 231A, 231B, and 231C may be co-located or may be geographically separated from one another. The power plants 231A, 231B, and 231C may connect to the power grid 215 at different places. For example, the power plant 231A may be connected to the power grid 215 upstream of where the power plant 231B is connected.

In some implementations, the power plant 231A associated with the power generation source 202 may include dedicated equipment for the control of the power plant 231A and/or for transition of electricity to/from the power plant 231A. For example, the power plant 231A may include a plant controller 212A and a power controller 110A and/or a transmission facility 230A. The power controller 210A and/or the transmission facility 230 may be connected in electrical communication with the plant controller 112A. The plant controller 212A may, for example, monitor and control the operations of the power controller 210A and/or the transmission facility 230A, such as via various control signals. As examples, the plant controller 212A may control the power controller 210A and/or transmission facility 230A to provide electricity from the power generation sources 202 to the power grid 215, etc.

Additionally, or alternatively, the power plant 231B associated with the LODES system 204 may include dedicated equipment for the control of the power plant 231B and/or for transmission of electricity to/from the power plant 231B. For example, the power plant 231B associated with the LODES system 204 may include a plant controller 112B, a power controller 210B, and/or a transmission facility 230B. The power controller 210B and/or the transmission facility 230B may be connected to the plant controller 212B. The plant controller 212B may monitor and control the operations of the power controller 210B and/or of the transmission facility 230B, such as via various control signals. As an example, the plant controller 212B may control the power controller 210B and/or the transmission facility 230B to provide electricity from the LODES system 204 to the power grid 215 and/or to provide electricity from the power grid 215 to the LODES system 204, etc.

Still further, or instead, the power plant 231C associated with the SDES system 260 may include dedicated equipment for the control of the power plant 231C and/or for transmission of electricity to/from the power plant 231C. For example, the power plant 231C associated with the SDES system 260 may include a plant controller 212C and a power controller 210C and/or a transmission facility 230C. The power controller 210C and/or the transmission facility 230C may be connected to the plant controller 212C. The plant controller 212C may monitor and control the operations of the power controller 210C and/or transmission facility 230C, such as via various control signals. As examples, the plant controller 212C may monitor and control the operations of the power controller 210C and/or transmission facility 230C, such as via various control signals. As examples, the plant controller 212 may control the power controller 210C and/or the transmission facility 230C to provide electricity from the SDES system 260 to the power grid 215 and/or to provide electricity from the power grid 215 to the SDES system 260, etc.

In various embodiments, the plant controllers 212A, 212B, 212C may each be in communication with each other and/or with a network 220. Using the connections to the network 220, the plant controllers 212A, 212B, 212C may exchange data with the network 220 as well as with one or more devices connected to the network 220, such as a plant management system 221, each other, or any other device connected to the network 220. In various embodiments, the operation of the plant controllers 212A, 212B, 212C may be monitored by the plant management system 221 and the operation of the plant controllers 212A, 212B, 212C—and, thus, operation of the power generation system 201, may be controlled by the plant management system 221.

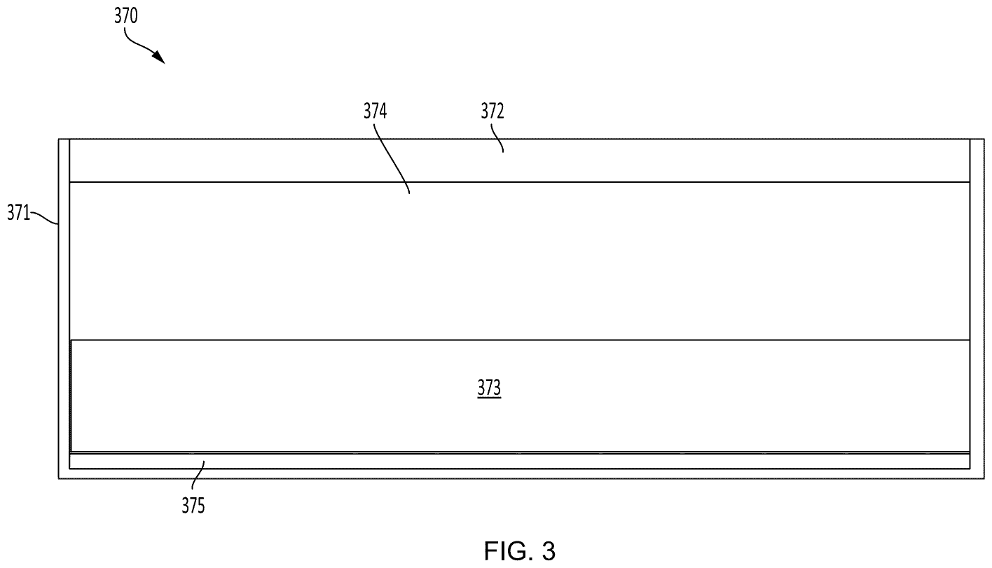

FIG. 3 is a schematic view of a battery 370 that may be used in the one or more LODES systems described herein (e.g., the LODES system 204 in FIG. 1 and/or the LODES system 204 in FIG. 2). The battery 370 may include a vessel 371, a gas diffusion electrode (GDE) 372, an anode 373, an electrolyte 374, and a current collector 375. The GDE 372, the anode 373, the electrolyte 374, and the current collector 375 may each be disposed in the vessel 371. The anode 373 may include a metal electrode (e.g., an iron electrode, a lithium electrode, a zinc electrode, or other type of suitable metal). The electrolyte 374 may separate the GDE 372 from the anode 373. Additionally, specific examples of batteries, such as batteries similar to battery 370, that may be used in bulk energy storage systems, such as in LODES systems of the present disclosure are described in U.S. Pat. App. Pub. 2021/0028457, the entire contents of which are incorporated herein by reference. As examples, the battery 370 may be a metal-air type battery, such as an iron-air battery, a lithium-air battery, a zinc-air battery, etc. While various examples are discussed with reference to metal-air batteries, other type batteries may be additionally, or alternatively, used in the various examples provided herein unless otherwise specified or made clear from the context. The battery 370 may be a single cell or unit, and multiple instances of the battery 370—namely, multiple units or cells—may be connected together to form a module. Multiple modules may be connected to one another to form a battery string.

In various embodiments, the anode 373 may be solid and the electrolyte may be excluded from the anode. In various embodiments the anode 373 may be porous and the electrolyte 374 may be interspersed geometrically with the anode 373, creating a greater interfacial surface area for reaction. Further, or instead, the air electrode 203 may be porous and the electrolyte 374 may be interspersed geometrically with the anode 373, creating a greater interfacial surface area for reaction. Still further, or instead, the GDE 372 may be at an interface of the electrolyte 374 and a gaseous headspace (not shown in FIG. 3). The gaseous headspace may, for example, be sealed in a housing. Additionally, or alternatively, the housing may be unsealed and the gaseous headspace may be an open system which can freely exchange mass with the environment.

The anode 373 may be formed from a metal or metal alloy, such as lithium (Li), sodium (Na), potassium (K), magnesium (Mg), calcium (Ca), silicon (Si), aluminum (Al), zinc (Zn), or iron (Fe); or alloys substantially comprised of one or more of the forgoing metallic elements, such as an aluminum alloy or iron alloy (e.g., FeAl, FeZn, FeMg, etc.) that can undergo an oxidation reaction for discharge. As such, the anode 373 may be referred to as a metal electrode herein.

In certain embodiments, the battery 370 may be rechargeable and the anode 373 may undergo a reduction reaction when the battery 370 is charged. The anode 373 may be a solid, including a dense or porous solid, or a mesh or foam, or a particle or collection of particles, or may be a slurry, ink, suspension, or paste deposited within the housing. In various embodiments, composition of the anode 373 may be selected such that the anode 373 and the electrolyte 374 do not mix together to any substantial extent, allowing for only small amounts of solubility that do not impact performance of the battery 370. For example, the anode 373 may be a metal electrode that may be a bulk solid. Further, or instead, the anode 373 may include a collection of particles, such as small or bulky particles, within a suspension, and the collection of particles may not be buoyant enough to escape the suspension into the electrolyte 374. Additionally, or alternatively, the anode 373 may include particles that are not buoyant in the electrolyte 374.

The GDE 372 may support the reaction with oxygen. As an example, the GDE 372 may be a solid and may sit at the interface of a gas headspace and the electrolyte 374. During the discharge process, the GDE 372 may support the reduction of oxygen from the gaseous headspace, in a reaction known as the Oxygen Reduction Reaction (ORR). In certain embodiments, the battery 370 may be rechargeable and the reverse reaction may occur—namely, the reaction in which the GDE supports the evolution of oxygen from the battery, in a reaction known as Oxygen Evolution Reaction (OER). The OER and ORR reactions are commonly known to those skilled in the art.

In various embodiments, the electrolyte 374 may be a liquid electrolyte. For example, the electrolyte 374 may be an aqueous solution, a non-aqueous solution, or a combination thereof. In various embodiments, the electrolyte 374 may be an aqueous solution which may be acidic (low-pH), neutral (intermediate pH), or basic (high pH; also called alkaline or caustic). In certain embodiments, the electrolyte 374 may comprise an electropositive element, such as Li, K, Na, or combinations thereof. In some embodiments, the liquid electrolyte may be basic, namely with a pH greater than 7. In some embodiments the pH of the electrolyte may be greater than 10 (e.g., greater than 12). For example, the electrolyte 374 may include a 6M (mol/liter) concentration of potassium hydroxide (KOH). In certain embodiments, the electrolyte 374 may include a combination of ingredients such as 5.5M potassium hydroxide (KOH) and 0.5M lithium hydroxide (LiOH). In certain embodiments, the electrolyte 374 may comprise a 6M (mol/liter) concentration of sodium hydroxide (NaOH). In certain embodiments, the electrolyte 374 may comprise a 5M (mol/liter) concentration of sodium hydroxide (NaOH) and 1M potassium hydroxide (KOH).

In certain embodiments, the battery 370 (e.g., metal-air battery) may discharge by reducing oxygen (O₂) typically sourced from air. This may achieved by a triple-phase contact between gaseous oxygen, an electronically active conductor which supplies the electrons for the reduction reaction, and the electrolyte 374 which contains the product of the reduction step. For example, in certain embodiments involving an aqueous alkaline electrolyte, oxygen from air may be reduced to form hydroxide ions through the half-reaction O₂+2H₂O+4e⁻→4OH⁻. Thus, oxygen delivery to metal-air cells may include gas handling and maintenance of triple-phase points. In certain embodiments, sometimes referred to as “normal air-breathing” configurations, the GDE 372 may be positioned at the gas-liquid interface to promote and maintain triple-phase boundaries. The GDE 372 may be positioned vertically or horizontally, or at any intermediate angle with respect to gravity, and maintain a “normal air-breathing” configuration. In these “normal air-breathing” configurations, the gas phase is at atmospheric pressure-that is, gas phase is unpressurized beyond the action of gravity.

The battery 370 in FIG. 3 is merely an example of one electrochemical cell according to various embodiments and is not intended to be limiting. Other configurations, such as electrochemical cells with different types of vessels and/or without the vessel 371, electrochemical cells with different types of air electrodes and/or without the GDE 372, electrochemical cells with different types of current collectors and/or without the current collector 375, electrochemical cells with different types of anodes and/or without the anode 373, and/or electrochemical cells with different types of electrolytes and/or electrochemical cells without the electrolyte 374 may be substituted for the example configuration of the battery 370, and other arrangements are in accordance with the various embodiments.

In various embodiments, the vessel 371 may be made from a polymer such as polyethylene, acrylonitrile butadiene styrene (ABS), high-density polyethylene (HDPE), ultra-high molecular weight polyethylene (UHMW), polypropylene, and/or other polymers. In certain embodiments, the vessel 371 and/or housing for the battery 370 may be made from a metal such as nickel, steel, anodized aluminum, nickel coated steel, nickel coated aluminum or other metal.

In various embodiments, a battery (e.g., the battery 370) may include three electrodes—an anode (e.g., the anode 373) and a dual cathode (e.g., GDE 372 including two parts, such as a first cathode, and a second cathode). The electrodes may have finite useful lifetimes, and may be mechanically replaceable. For example, the anode may be replaced seasonally. The first cathode of the dual cathode may be divided into two portions, a first portion having a hydrophilic surface and a second portion having a hydrophobic surface. For example, the hydrophobic surface may have a polytetrafluorethylene (PTFE) (e.g., Teflon®) hydrophobic surface.

For example, the second portion having the hydrophobic surface may include a microporous layer of polytetrafluorethylene (PTFE) and high surface area carbon while the first portion having the hydrophilic surface may include carbon fiber partially coated with PTFE. As another example, the second portion may include a microporous layer of PTFE and carbon black and the first portion may include PTFE of approximately 33% by weight. As a further example, the second portion may include a microporous layer of 23% by weight PTFE and 77% by weight carbon black and the first portion may include a low loading microporous layer. The anode may be an iron (Fe) electrode or an iron-alloy (Fe-alloy) electrode (e.g., FeAl, FeZn, FeMg, etc.). The second cathode of the dual cathode may include a hydrophilic surface. The second cathode of the dual cathode may include a metal substrate, such as carbon (C), titanium (Ti), steel, etc., coated with nickel (Ni). Electrolyte (e.g., electrolyte 140) may be disposed between the three electrodes. The electrolyte may be infiltrated into one or more of the three electrodes.

Battery systems may include a number of cells connected in series and/or parallel in a shared electrolyte bath and contained in a housing.

Referring now to FIGS. 1-4C, FIG. 4A an electrochemical cell 400 may include at least one battery, such as at least one instance of the battery 200, in accordance with various embodiments. In some implementations, the electrochemical cell 400 may include a vessel 401 (e.g., such as the vessel 371), in which an air electrode (e.g., a cathode), such as the GDE 372, a negative electrode (e.g., an anode), such as the anode 373, and an electrolyte, such as the electrolyte 374, are disposed. The electrolyte, such as the electrolyte 374, may rise to a given level within the vessel 401 and a headspace between the top of the vessel 401 and electrolyte level may be formed in the electrochemical cell 400. The vessel 401 may have a height (e.g., a z dimension), a width (e.g., a y dimension), and a depth (e.g., a x dimension). In one example configuration, the height may be greater than the width and depth and the width may be greater than the depth such that the vessel 401 is a generally rectangular cuboid. The vessel 401 may include one or more various connections, such as electrical connections, electrolyte connections, gas connections (e.g., air connections), vents, etc. Via the connections, two or more electrochemical cells (e.g., two or more instances of the electrochemical cell 400) may be connected together, such as in series and/or in parallel, to form a module.

In a module formed of a plurality of instances of the electrochemical cell 400, each instance of the electrochemical cell 400 may be a self-contained unit supporting its own respective air electrode (e.g., the GDE 372), anode electrode (e.g., the anode 373), and electrolyte (e.g., the electrolyte 374). The module structure may support the vessel 401 of the electrochemical cells 400 disposed within the given module.

The vessel 401 may have disposed within it one or more instances of an anode assembly 402a,b (e.g., one or more instances of the anode 373), one or more instances of a cathode (e.g., the air electrode 203), and an electrolyte (e.g., the electrolyte 374). As an example, each instance of the cathode assembly may include a respective instance of an Oxygen Evolution Electrode (OEE) 403a,b and a gas diffusion electrode (GDE) 404. A battery including at least one instance of the OEE 403 and at least one instance of the GDE 404 may be referred to as a multi-cathode battery cell.

A first OEE 403a may be disposed within the vessel 401, between a first anode assembly 402a and the GDE 404. On the opposite side of the GDE 404, a second OEE 403b and a second anode assembly 402b may be in a mirror configuration relative to the GDE 404. That is, within the vessel 401, the GDE 404 may be disposed between symmetric arrangements of: 1) the first anode assembly 402a and the first OEE 403a; and 2) the second anode assembly 402b and the second OEE 403b. As a specific example, the GDE 404 may be disposed centrally within a volume defined by the vessel 401, such that the length and width of the GDE 404 is at least partially disposed along a center plane defined by the length and width of the volume defined by the vessel 401 and intersecting a midpoint of the depth dimension of the volume defined by the vessel 401. Air may enter the volume of the vessel 401 and pass into the GDE 404 (e.g., into a center portion of the GDE 404) between the first OEE 403a and the second OEE 403b. The electrochemical cell 400 may include first standoff elements 451 between the first anode assembly 402a and the first OEE 403a and between the second anode assembly 402b and the second OEE 403b. Further, or instead, the electrochemical cell 400 may include second standoff elements 452 between the first OEE 403a and the GDE 404 and between the second OEE 403b and the GDE 404. However, such internal arrangement of the electrochemical cell 400 is merely one example configuration within the vessel 401, and is not intended to be limiting.

In some implementations, the electrochemical cell 400 may include an electronics structure 450, which may include a printed circuit board assembly (PCBA), circuitry housing, etc., as may be useful for supporting various electronic devices (e.g., controllers, sensors, switches, wiring buses, etc.) that may control and/or manage one or more operations of the electrochemical cell 400. The electrochemical cell 400 may additionally, or alternatively, include a lid 455 and an electrode holder 454 on opposite sides along a length dimension of the vessel 401. Straps 453 may secure the lid 455 and the electrode holder 454 to the vessel 401. The electronics structure 450 may be supported on the lid 455 in some configurations.

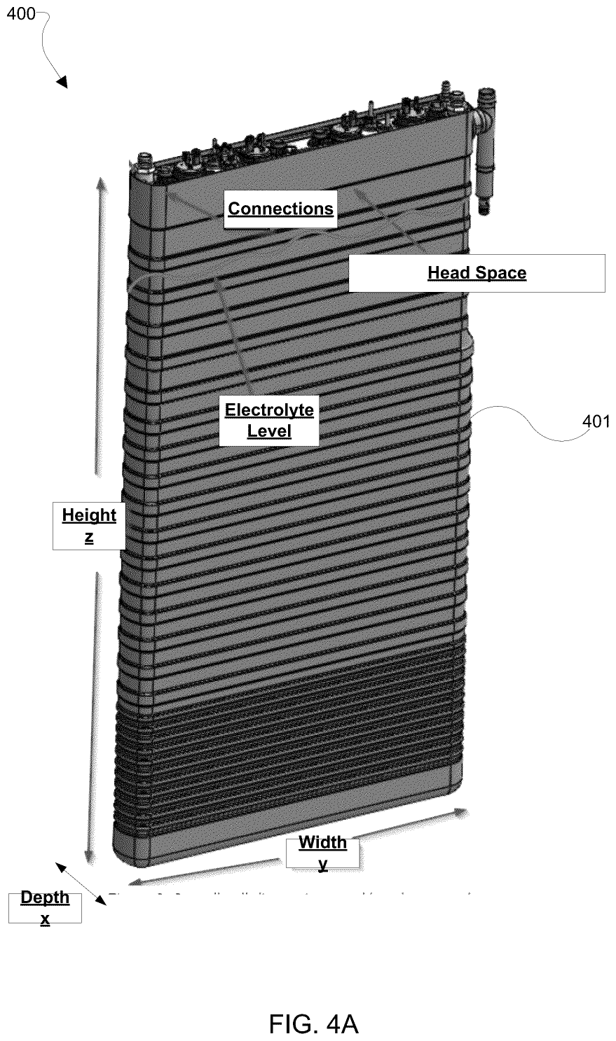

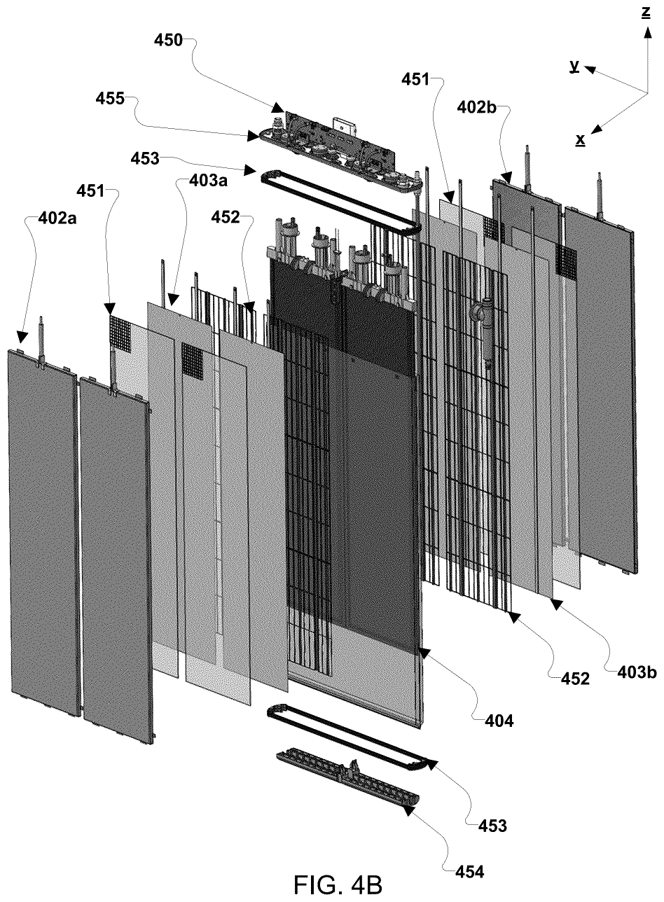

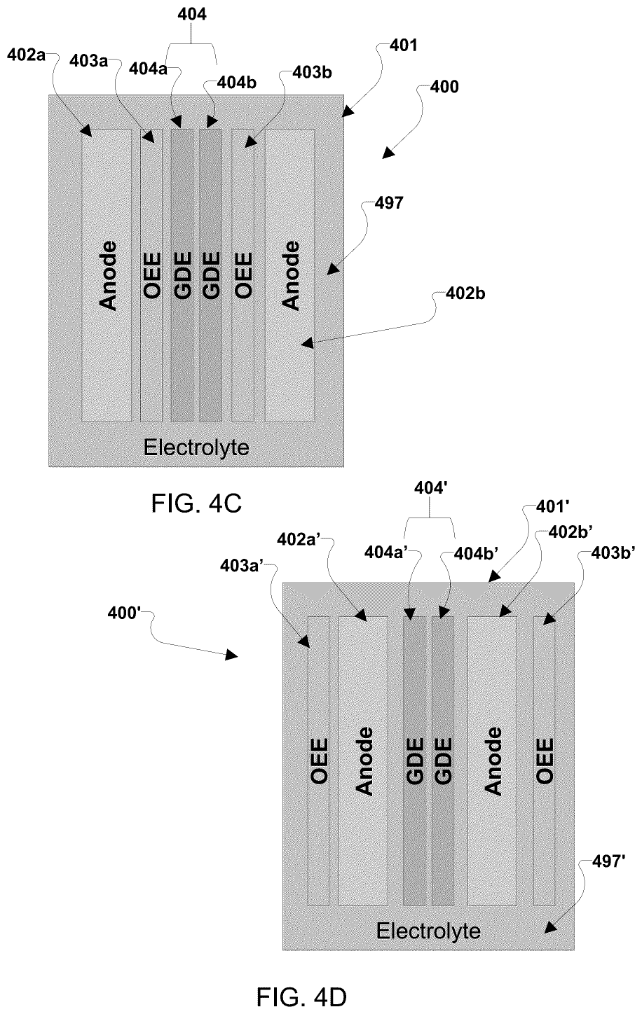

In general, the first OEE 403a, the first anode assembly 402a, the GDE 404, the second OEE 403b, and the second anode assembly 402b may each be disposed in an electrolyte 497 within the volume of the vessel 401 of the electrochemical cell 400. As discussed herein, the GDE 404 may include a two part electrode with two faces sealed on three-sides to form a two-faced pocket construction defining a central air passage between the two faces. As compared to other configurations, the amount of inactive material used in construction of the GDE 404 (e.g. flowfield, epoxy “trough” or frame) may be reduced by making a 2-sided GDE (air in the middle with active faces on either side). To facilitate construction of the GDE 404, the first anode assembly 402a and the first OEE 403a may be mirrored about the GDE 404 by the second anode assembly 402b and the second OEE 403b. Along the depth dimension of the vessel 401, in a direction from right to left in FIG. 4C, a construction of electrodes within the vessel 401 of the electrochemical cell 400 may be: the first anode assembly 402a|the first OEE 403a|a first portion 404a of the GDE 404|a second portion 404b of the GDE 404|the second OEE 403b|the second anode assembly 402b. For ease of manufacturing and assembly, each electrode may be further divided into two mechanically distinct electrodes across the width dimension of the vessel 401—thus resulting in the electrochemical cell having 4 anodes (e.g., two instances of the first anode assembly 402a and two instances of the second assembly 402b), 4 OEEs (e.g., two instances of the first OEE 403a and two instances of the second OEE 403b), and two instances of the GDE 404. Electrically and electrochemically, all electrodes may function as a parallel circuit (e.g. common potential among all anodes).

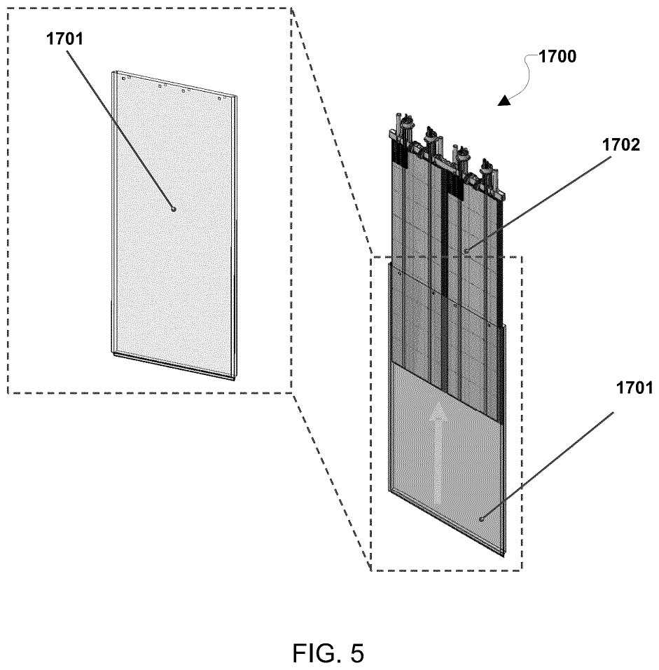

FIG. 5 is a schematic representation of a cathode 1700 including a separator 1701 and a cathode subassembly 1702 (e.g., the first OEE 403a and/or the second OEE 403b in FIG. 4B). As an example, the separator 1701 may include separator material in the form of sheets and/or a bag. As a specific example, the separator 1701 may be formed by folding one large sheet of separator material and sealing the edges or taking two individual sheets of separator material and sealing them together along three edges. Thus, the separator 1701 may be open at the top. The cathode subassembly 1702 may be inserted into the of the separator 1701. The separator 1701 may be ionically conductive, allowing ions to pass through freely, but electrically insulative to prevent electrical shorting between electrodes. Further, or instead, the material of the separator 1701 may allow ions to pass while not allowing electrolyte additive species to pass. Further, or instead, the separator 1701 may be impermeable to bubbles generated by the cathode subassembly 1702 such that the bubbles do reach the anode (e.g., the first anode assembly 402a and/or the second anode assembly 402b in FIG. 4B). Likewise, the material of the separator 1701 may be impermeable to bubbles from the anode such that these bubbles do not reach the cathode subassembly 1702. The sealed bottom of the separator 1701 may also reduce the likelihood of, or even prevent, electrical shorting due to particulates that may accumulate at the bottom of the electrochemical cell between the electrodes. In another embodiment, the bottom of the separator 1701 may be open instead of sealed, resulting in a sleeve-like design.

Electrodes in the vessel of an electrochemical cell may require electrical isolation from each other. Each electrode operates at a different potential. Some electrodes cannot operate at the same potential as others in the system. If an electrode A is not compatible with the potential of electrode B, shorting of the two electrodes may result in degradation of either electrode. During cycling, some electrodes produce bubbles which can coalesce and cause blocking between the electrodes. Blocking between electrodes can increase ohmic resistance, cause mass transport issues, dry out an electrode resulting in loss of performance, locally deteriorate the surface of an electrode, and/or have other negative effects to the cell. Additionally, or alternatively, certain electrode operating potentials may lead to the degradation of plastics used as separator materials and can lead to shorting.

Various embodiments may include a standoff and separator to reduce the likelihood of shorting between the charge electrodes (e.g., the first anode assembly 402a and the second anode assembly 402b and either one of the first OEE 403a and the second OEE 403b). Unless otherwise specified or made clear from the context, it shall be understood that the various standoff arrangements in the paragraphs that follow may be used in any one or more of the various different electrochemical cell configurations described herein. Thus, for the sake of efficient description, repetition of the features of electrochemical cells compatible with the standoff arrangements that follow are generally not repeated.

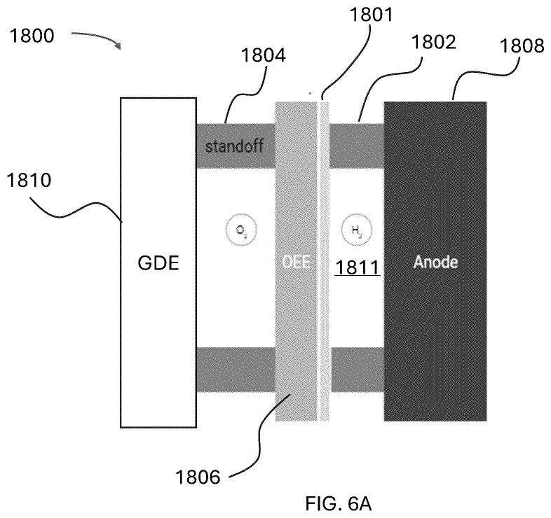

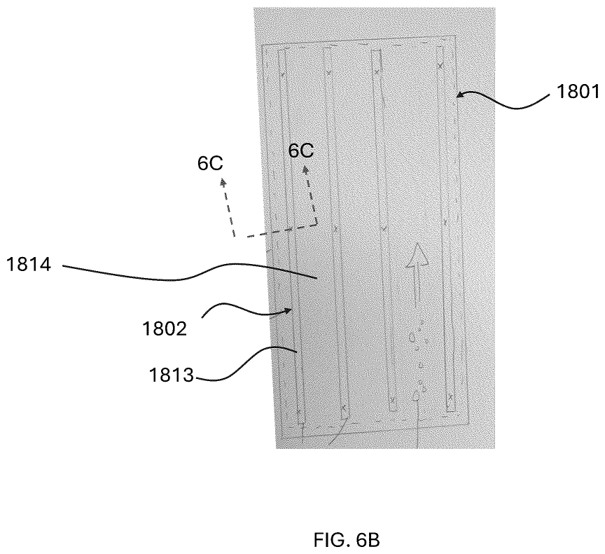

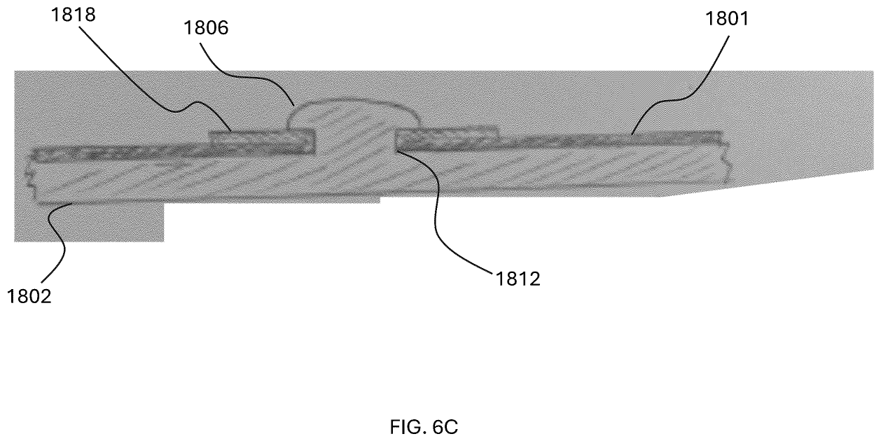

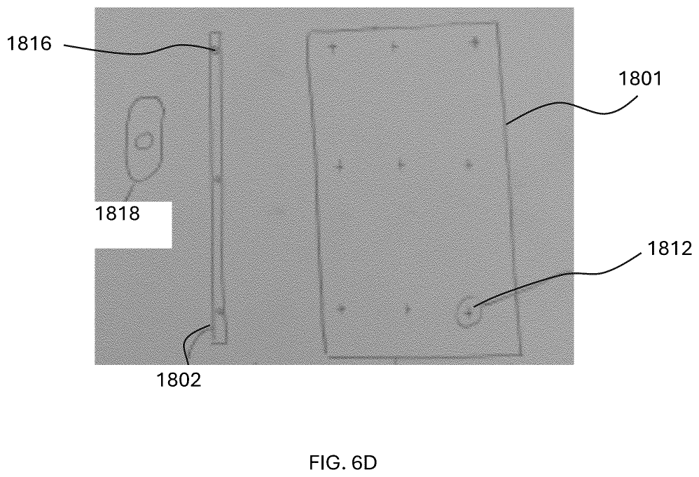

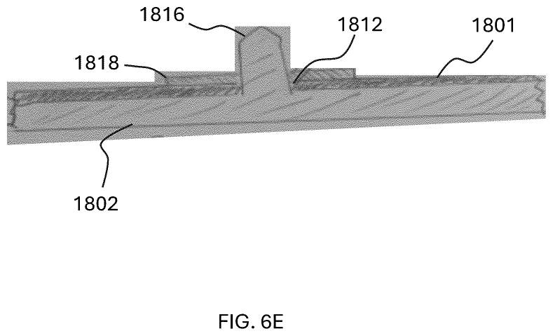

Referring now to FIG. 6A, an electrochemical cell 1800 may include a separator 1801, a first standoff 1802, a second standoff 1804, an oxygen evolution electrode (OEE) 1806, an anode 1808, and a gas diffusion electrode (GDE) 1810. The separator 1801 and the first standoff 1802 may be disposed between the OEE 1806 and the anode 1808, and the second standoff 1804 may be disposed between the GDE 1810 and the OEE 1806. For the avoidance of doubt, it shall be understood that the OEE 1806, the anode 1808, and the GDE 1810 may include any one or more features of any of the respective type of electrode described herein and repetition of such features is generally avoided for the sake of efficient description. Thus, for example, the anode 1808 may be a metal anode (e.g., an iron electrode) and or instead, the electrochemical cell 1800 may include an electrolyte 1811 in which the anode 1808, the OEE 1806, and the GDE 1810 are each at least partially submerged in the volume of a vessel (e.g., the vessel 401 in FIG. 4A). Further, in the portion of the disclosure that follows, each of a plurality of instances of a feature shall be understood to be identical to one another and, thus, for term “plurality” is occasionally omitted in instances in which clear explanation and linguistic convenience are served by reference to only a single instance of a plurality of a certain feature.

In general, the separator 1801 and the first standoff 1802 may reduce the likelihood of shorting between the OEE 1806 and the anode 1808 while providing space for oxygen bubble egress from an electrolyte 1811 along the separator 1801. That is, the separator 1801 may be impermeable to bubbles formed during operation of the electrochemical cell 1800 (e.g., bubbles generatable by the anode 1808) such that the bubbles remain between the separator 1801 and the anode 1808, where the bubbles may flow upward through the electrolyte 1811. In certain implementations, the separator 1801 may be ionically conductive while also being electrically insulating to reduce the likelihood of shorting between electrodes. Further, or instead, the separator 1801 may allow ions to pass while not allowing electrolyte additive species to pass. As an example, the separator 1801 may be a microporous film (e.g., a polymeric film such as polypropylene).

Referring now to FIGS. 6A and 6B, at least one instance of the first standoff 1802 may space the OEE 1806 from the anode 1808 with the at least one instance of the first standoff 1802 penetrating the separator 1801 at discontinuities 1812 and forming at least a portion of respective liquid tight seals with the separator 1801 at the discontinuities 1812 through which the first standoff 1802 penetrates the separator 1801. As compared to placement of other plastic components during an assembly process, penetration of the at least one instance of the first standoff 1802 through the separator 1801 may facilitate cost-effectively providing structure that resists collapse along the entire dimension of the space between the OEE 1806 and the anode 1808 while maintaining integrity and continuity of the barrier provided by the separator 1801 between the OEE 1806 and the anode 1808.

In general, the at least one instance of the first standoff 1802 may be any one or more of various different shapes useful for efficient and reliable assembly while also providing robust resistance to contact between the OEE 1806 and the anode 1808. As an example, the at least one instance of the first standoff 1802 may include an elongate body 1813 and may penetrate the separator 1801 at the discontinuities along a longitudinal dimension of the elongate body 1813. Continuing with this example, the elongate shape of the at least one instance of the first standoff 1802 may facilitate handling during assembly. Further, or instead, in an installed position on the separator 1801, the at least one instance of the first standoff 1802 may define at least a portion of a channel 1814 useful for, among other things, guiding egress of bubbles through the electrolyte 1811, as may be useful for reducing the likelihood of concentrations of bubbles exiting the electrolyte 1811 at specific points along a surface of the electrolyte 1811.

The at least one instance of the first standoff 1802 may be electrically insulating to reduce the likelihood of a short forming in the small space between the OEE 1806 and the anode 1808. Further, or instead, the at least one instance of the first standoff 1802 may be rigid to maintain the spacing between the OEE 1806 and the anode 1808. Still further, or instead, the at least one instance of the first standoff 1802 may be inexpensive, as may be useful for cost-effective fabrication of the electrochemical cell 1800. Thus, as an example, the at least one instance of the first standoff 1802 may be polymeric. As a specific example, the at least one instance of the first standoff 1802 may be formed of polymer having a melt temperature less than a melt temperature of the separator 1801, as may be useful for providing a short in the event of a high temperature event that melts the separator 1801.

Referring now to FIGS. 6A-6C, the at least one instance of the first standoff 1802 may include a plurality of instances of a boss 1816 and a plurality of instances of a washer 1818. The washer 1818 may be polymeric, as is generally cost-effective and useful for reducing the likelihood of unintended shorting. Unless otherwise specified or made clear from the context, each instance of the boss 1816 and the washer 1818 may form the same type of attachment between the first standoff 1802 and the separator 1801. Accordingly, for the sake of clarity of description, only a single instance of the attachment is described.

The boss 1816 may be supported on the elongate body 1813 of the first standoff 1802. The boss 1816 may penetrate the separator 1801 at an instance of the discontinuities 1812. The boss 1816 may be heat staked on the washer 1818 with the separator 1801 sandwiched between the washer 1818 and the elongate body 1813 of the first standoff 1802. That is, the boss 1816 heat staked on the washer 1818 may form a liquid tight seal such that the electrolyte 1811 does not flow through the separator 1801 at the discontinuity 1812 at which the boss 1816 is heat staked on the washer 1818. Thus, it shall be appreciated that this is a cost-effective and robust approach to attaching the first standoff 1802 to the separator 1801.

Referring now to FIGS. 6D and 6E, given that the separator 1801 may be formed of a tough material that may be difficult to penetrate, the discontinuities 1812 in the separator 1801 may be preformed. Among other things, preforming the discontinuities 1812 may facilitate precise placement of the discontinuities which may facilitate aligning the plurality of instances of the boss 1816 with respective instances of the discontinuities 1812. That is, during assembly, the boss 1816 may extend through the thickness of the separator 1801 at an instance of the discontinuities 1812. With the boss 1816 extending through the separator 1801, the washer 1818 may be placed on a side of the separator 1801 opposite the elongate body 1813 of the first standoff 1802. The boss 1816 may be deformed (e.g., by heat staking) to secure the boss 1816 to the washer 1818 and, thus, secure the first standoff 1802 securely in place on the separator 1801. Further, the boss 1816 deformed on the washer 1818 may hold the washer 1818 in place such that a liquid tight seal is formed at the discontinuity 1812. Still further, or instead, since the separator 1801 may melt at a lower temperature than many plastics, the washer 1818 may serve as a plastic landing pad capable of withstanding heat of the heat staking process such that the separator 1801 is less likely to become damaged during the heat staking process.

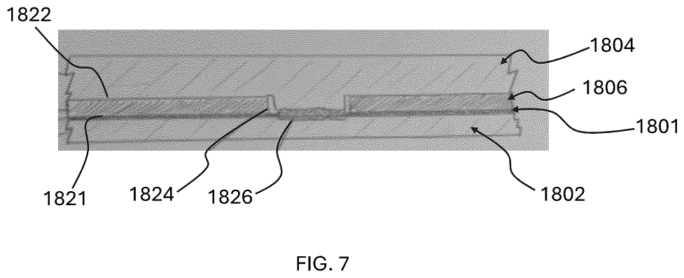

Referring now to FIG. 6A and FIG. 7, while the positioning of the first standoff 1802 has been described for maintaining spacing between the OEE 1806 and the anode 1808, it shall be appreciated that penetration through the separator 1801 may be additionally used to facilitate cost-effective and robust placement of the second standoff 1804 between the OEE 1806 and the GDE 1810.

In general, the OEE 1806 may have a first surface 1821 and a second surface 1822 opposite one another. The OEE may define a plurality of instances of a hole 1824 from the first surface 1821 to the second surface 1822. The separator 1801 may be sandwiched between the first surface 1821 of the OEE 1806 and at least one instance of the first standoff 1802. Further, or instead, the at least one instance of the second standoff 1804 may be disposed on the second surface 1822 of the OEE 1806. Continuing with this example, the first standoff 1802, the separator 1801, and the second standoff 1804 may be mechanically secured to one another through the plurality of instances of the hole 1824 of the OEE 1806. In particular, the mechanical coupling between the first standoff 1802, the separator 1801, and the second standoff 1804 through the hole 1824 may form a liquid tight seal over the hole 1824, as may be useful for maintaining the performance of the electrochemical cell 1800.

In general, the first standoff 1802, the separator 1801, and the second standoff 1804 may be mechanically coupled to one another through the hole 1824 using any one or more of various different techniques that may be cost-effectively and robustly implemented in a full-scale manufacturing setting. Thus, for example, the first standoff 1802, the separator 1801, and the second standoff 1804 may be coupled to one another at a weld 1826 (e.g., an ultrasonic weld) extending through a respective instance of the hole 1824 of the OEE 1806. As an example, the first standoff 1802, the second standoff 1804 or both may include a plurality of instances of a protrusion (e.g., the boss 1816 of the first standoff 1802 in FIG. 6E). Continuing with this example, the protrusion may form a portion of the corresponding the weld 1826 extending through the hole 1824 of the OEE 1806. Among other things, such a protrusion may be useful for holding the first standoff 1802 and/or the second standoff 1804 in place through the hole 1824 as the weld 1826 is formed. Further, or instead, the additional material of the protrusion may be useful for forming the weld 1826 such that the weld 1826 seals the hole 1824 of the OEE 1806.

While the application of energy (e.g., in the form of heat and/or welding) has been described as useful for securing the first standoff 1802 and/or the second standoff 1804 relative to the separator 1801 in the electrochemical cell 1800, it shall be appreciated that other types of sealed mechanical couplings are additionally or alternatively possible.

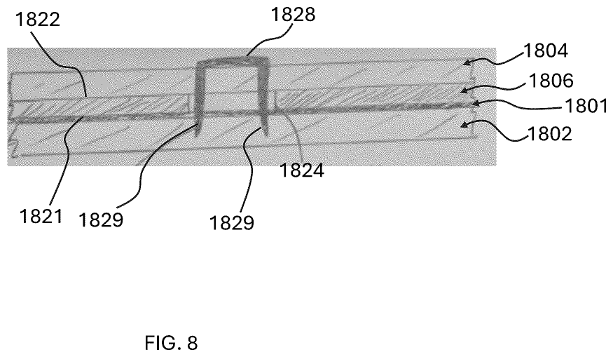

For example, referring now to FIG. 6A and FIG. 8, a plurality of instances of a polymeric staple 1828 may be used in addition to or in place of the weld 1826 (FIG. 7) to hold the first standoff 1802 and the second standoff 1804 in place in the electrochemical cell 1800. That is, the polymeric staple 1828 may extend through the hole 1824 of the OEE 1806, with the polymeric staple 1828 mechanically coupling the first standoff 1802, the separator 1801, and the second standoff 1804 to one another. As an example, the polymeric staple 1828 may include a pair of points 1829 extending in a direction toward the anode 1808 such that only the pair of points 1829 penetrate the separator 1801. Because the pair of points 1829 of the polymeric staple 1828 forms only small punctures that are closely dimensioned to the pair of points 1829, the separator 1801 may seal around the pair of point 1829. As compared to other mechanical coupling techniques, the use of the polymeric staple 1828 may offer advantages with respect to manufacturing throughput and/or cost-effectiveness.

While the first standoff 1802 has been described as being a separate component securable to the separator 1801, it shall be appreciated that other arrangements of the first standoff 1802 relative to the separator 1801 are additionally or alternatively possible.

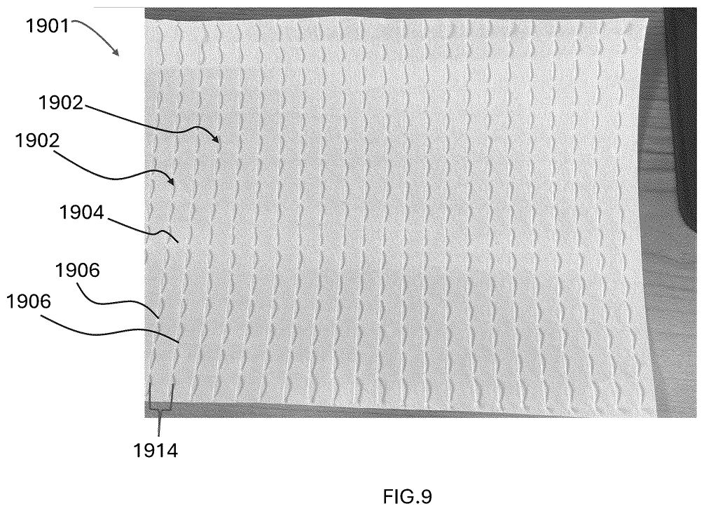

For example, referring now to FIG. 9, a separator 1901 for an electrochemical cell such as the electrochemical cell 1800 (FIG. 6A) may include a plurality of filaments 1902 and a substrate 1904. The substrate 1904 may be ionically conductive and electrically insulative. The plurality of filaments 1902 may extend in a direction away from the substrate 1904 with each one of the plurality of filaments 1902 attached to the substrate 1904 at discrete locations 1906 along a longitudinal dimension of the respective filament 1902. That is, the plurality of filaments 1902 secured to and extending from the substrate 1904 may act as a standoff to maintain spacing between the separator 1901 and an anode of the electrochemical cell. That is, with the plurality of filaments 1902 attached to the substrate 1904 at discrete locations 1906 along the longitudinal dimension of each filament 1902, the diameter of each filament 1902 acts as a standoff. As compared to techniques requiring attachment of a standoff to a separator, it shall be appreciated that the separator 1901 may offer significant advantages with respect to manufacturing throughput and reliability of performance. Unless otherwise specified or made clear from the context, it shall be understood that the separator 1901 may be used in place of the separator 1801 and the first standoff 1802 (FIG. 6A).

In general, the plurality of filaments 1902 may be attached to the substrate 1904 at discrete locations using any one or more of various, different techniques compatible with the material of the plurality of filaments 1902 and the substrate 1904. Thus, for example, each of the plurality of filaments 1902 may be attached to the substrate at the discrete locations by welds at the discrete locations. The welds may be placed at the discrete locations 1906 as part of a continuous fabrication process for the separator 1901. Further, or instead, the substrate 1904 and the plurality of filaments 1902 may each be polymeric (e.g., each may be a polyolefin-based polymer) to facilitate securing the plurality of filaments 1902 to the substrate 1904 using welds as part of a continuous or semi-continuous process (e.g., as part of an extrusion process). Further, or instead, the substrate 1904 may be a nonwoven material, as may be useful for providing ionic conductivity while providing electrical insulation.

In certain implementations, each of the plurality of filaments 1902 may have a circular cross-section away from the discrete locations 1906 of attachment of the plurality of filaments 1902 to the substrate 1904. The symmetry of such circular cross-section may be useful for reducing the need to position the plurality of filaments 1902 in any particular orientation relative to the substrate 1904. That is, the diameter of the plurality of filaments 1902 may provide consistent and reliable spacing between the substrate 1904 and the anode of an electrochemical cell and, thus, between the OEE and the anode of the electrochemical. As an example, each of the plurality of filaments 1902 may have a diameter of 1 mm to 2 mm away from the discrete locations 1906 of attachment of the plurality of filaments 1902 to the substrate 1904. Thus, continuing with this example, the plurality of filaments 1902 may space the substrate 1904 a distance of 1 mm to 2 mm away from the anode of the electrochemical cell. As may be appreciated, as compared to the use of other types of spacing techniques, the use of the diameter of the plurality of filaments 1902 to achieve such spacing may be cost-effective and reliable.

In certain implementations, the plurality of filaments 1902 may be electrically insulative and ionically impermeable. Thus, the plurality of filaments 1902 may block some of the available area of the substrate 1904 for ion permeability. Accordingly, there exists a tradeoff between the effectiveness of the plurality of filaments 1902 in acting as a standoff between the OEE and the anode of an electrochemical cell versus a decrease in ionic permeability of the substrate 1904. To balance this tradeoff, the plurality of filaments 1902 may cover 5 percent to 30 percent of the overall area of the substrate 1904. In this range, the plurality of filaments 1902 provide reliable spacing between the OEE and the anode of the electrochemical cell and the degradation in ionic permeability through the substrate 1904 is low enough that performance of the electrochemical cell is not materially impacted.

In general, the plurality of filaments 1902 may be spaced relative to one another according to any one or more different patterns. As an example, the plurality of filaments 1902 may be discretely spaced apart from one another. As a specific example, the plurality of filaments 1902 may be parallel to one another such that the plurality of filaments 1902 define a plurality of channels 1914 therebetween. Further, or instead, the plurality of filaments 1902 may be in a linear orientation along the substrate 1904.

While the plurality of filaments 1902 has been shown as being parallel to one another and linearly arranged on the substrate 1904, it shall be appreciated that other orientations are additionally or alternatively possible.

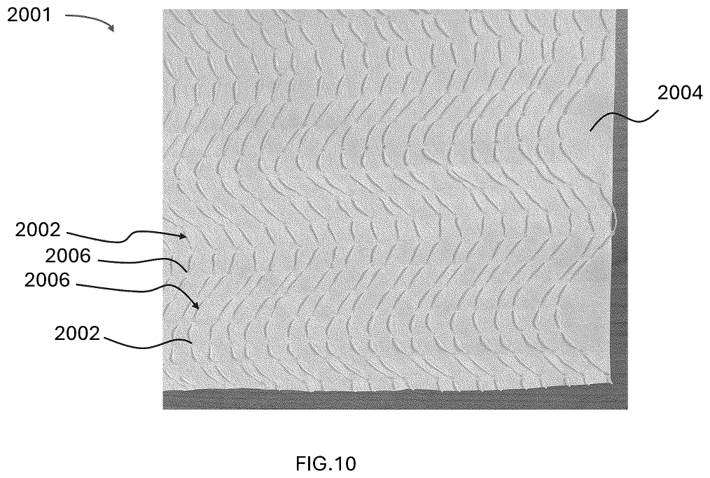

For example, referring now to FIG. 10, a separator 2001 may include a plurality of filaments 2002 attached to a substrate 2004 at discrete locations 2006. It shall be appreciated that the separator 2001 may be analogous to the separator 1901 (FIG. 9), except that the plurality of filaments 2002 are arranged in a curvilinear orientation on the substrate 2004.

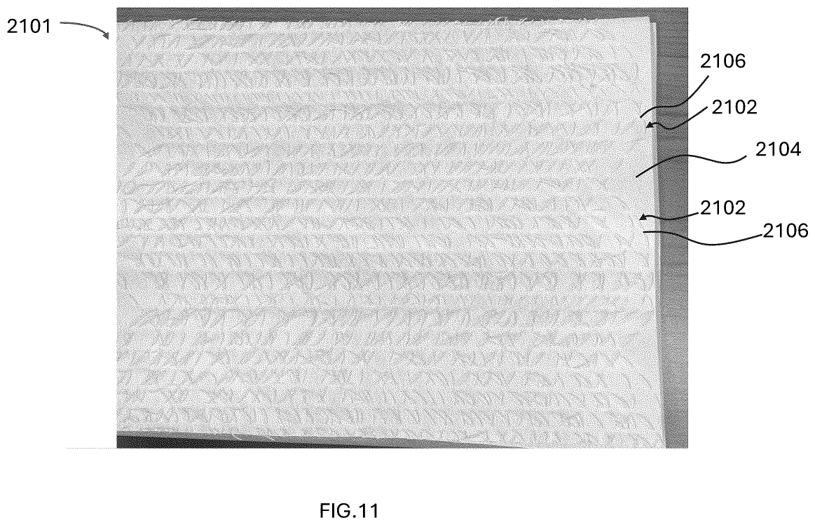

As another example, referring now to FIG. 11, a separator 2101 may include a plurality of filaments 2102 attached to a substrate 2104 at discrete locations 2106. It shall be appreciated that the separator 2101 may be analogous to the separator 1901 (FIG. 9) and the separator 2001 (FIG. 10), except that the plurality of filaments 2102 are arranges such that at least a subset of the plurality of filaments 2102 attached to the substrate 2104 partially overlap one another.

The foregoing method descriptions and the process flow diagrams are provided merely as illustrative examples and are not intended to require or imply that the steps of various embodiments should be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular. Herein, “about” may refer to a range of +/−5%.

Further, any step of any embodiment described herein can be used in any other embodiment. The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. An electrochemical cell comprising:
an anode;
a gas diffusion electrode (GDE);
an oxygen evolution electrode (OEE);
a vessel defining a volume in which the OEE, the GDE, and the anode are each at least partially disposed with the OEE between the anode and the GDE;
a separator, the separator ionically conductive and electrically insulative, the separator between the anode and the OEE; and
at least one first standoff spacing the OEE from the anode, the at least one first standoff penetrating the separator at discontinuities and forming at least a portion of respective liquid tight seals with the separator at the discontinuities.

2. The electrochemical cell of claim 1, wherein the at least one first standoff includes an elongate body, and the at least one first standoff penetrates the separator at the discontinuities along a longitudinal dimension of the elongate body.

3. The electrochemical cell of claim 2, wherein the at least one first standoff is a plurality of first standoffs spaced apart from one another between the OEE and the anode such that the plurality of first standoffs define at least one channel, between the OEE and the anode, along which bubbles from the anode are flowable.

4. The electrochemical cell of claim 2, wherein the at least one first standoff is polymeric.

5. The electrochemical cell of claim 2, wherein the at least one first standoff includes a plurality of bosses and a plurality of washers, each one of the plurality of bosses is supported on the elongate body and penetrates the separator at the discontinuities, and each one of the plurality of bosses is heat staked on a respective one of the plurality of washers with the separator sandwiched between the respective one of the plurality of washers and the elongate body.

6. The electrochemical cell of claim 1, further comprising at least one second standoff, wherein the at least one second standoff spaces the OEE away from the GDE.

7. The electrochemical cell of claim 6, wherein the OEE has a first surface and a second surface opposite one another, the OEE defines a plurality of holes from the first surface to the second surface, the separator is sandwiched between the first surface of the OEE and the at least one first standoff, the at least one second standoff is disposed on the second surface of the OEE, and the at least one first standoff, the separator, and the at least one second standoff are mechanically secured to one another through the plurality of holes of the OEE.

8. The electrochemical cell of claim 7, wherein the at least one first standoff, the at least one second standoff, and the separator collectively form liquid tight seals over the plurality of holes defined by the OEE.

9. The electrochemical cell of claim 7, wherein the at least one first standoff, the separator, the at least one second standoff are mechanically coupled to one another at a plurality of ultrasonic welds, and each one of the plurality of ultrasonic welds extends through a respective one of the plurality of holes of the OEE.

10. The electrochemical cell of claim 7, further comprising a plurality of polymeric staples, wherein each one of the plurality of polymeric staples extends through a respective one of the plurality of holes of the OEE and mechanically couples the at least one first standoff, the separator, and the at least one second standoff to one another.

11. The electrochemical cell of claim 1, wherein the separator is impermeable to bubbles generatable by the anode.

12. The electrochemical cell of claim 1, wherein the separator is a polymeric film.

13. The electrochemical cell of any one of the preceding claims, further comprising an electrolyte, wherein the anode, the OEE, and the GDE are each at least partially submerged in the electrolyte in the volume of the vessel.

14. A separator for an electrochemical cell, the separator comprising:
a plurality of filaments; and
a substrate, the substrate ionically conductive and electrically insulative, the plurality of filaments extending in a direction away from the substrate, and each of the plurality of filaments attached to the substrate at discrete locations along a longitudinal dimension of the respective filament.

15. The separator of claim 14, wherein attachment of each of the plurality of filaments to the substrate at the discrete locations includes welds at the discrete locations.

16. The separator of claim 14, wherein the substrate of the separator is a nonwoven material.

17. The separator of claim 14, wherein the substrate and the plurality of filaments are each polymeric.

18. The separator of claim 14, wherein the plurality of filaments are discretely spaced apart from one another.

19. The separator of claim 14, wherein each of the plurality of filaments has a circular cross-section away from the discrete locations of attachment of the plurality of filaments to the substrate.

20. The separator of claim 19, wherein each of the plurality of filaments has a diameter of 1 mm to 2 mm away from the discrete locations of attachment of the plurality of filaments to the substrate.
